(19) United States
(12) Patent Application Publication
(10) Pub. No.: US 2014/0091649 A1
(43) Pub. Date: Apr. 3, 2014

(54) ELECTROMAGNETIC INTERFERENCE SHIELD AND BALANCE RING FOR ELECTRICAL MACHINE

(71) Applicant: REMY TECHNOLOGIES, LLC, Pendleton, IN (US)

(72) Inventors: Andrew Dragon, Fishers, IN (US); David Fulton, Anderson, IN (US)

(73) Assignee: REMY TECHNOLOGIES, LLC, Pendleton, IN (US)

(21) Appl. No.: 13/633,308

(22) Filed: Oct. 2, 2012

(51) Int. Cl. H02K 5/24; H02K 15/00

(52) U.S. Cl. 310/51; 29/598

(57) ABSTRACT

An electrical machine including a stator and a rotor assembly. The rotor assembly defines a rotational axis and has a rotor core wherein the rotor core defines first and second axial end surfaces. A balance ring is rotationally fixed to the rotor assembly and is configured to rotationally balance the rotor assembly. The balance ring comprises an electrically conductive and magnetically permeable material and is disposed proximate the first axial end surface and defines an air gap disposed axially between the balance ring and the first axial end surface. In some embodiments, the electric machine includes a plurality of spacers extending between the first axial end surface and the balance ring. The rotor core and balance ring may comprise a plurality of stacked electrical steel laminations. The balance ring can be used to provide electromagnetic interference shielding for a resolver. A method of manufacturing an electric machine is also disclosed.

### BACKGROUND

The present invention relates to electrical machines such as motors and generators.

The normal operation of electrical machines such as motors and generators creates electromagnetic fields. Contemporary electrical machines are increasingly using electronic controls and sensors to control the operation of the electrical machines. The operation of some of these electronic components can be degraded by electromagnetic interference generated by the operation of the electrical machine.

### SUMMARY

The present invention provides a balance ring that also provides electromagnetic interference shielding properties.

One embodiment comprises an electrical machine that includes a stator and a rotor assembly. The rotor assembly defines a rotational axis and has a rotor core wherein the rotor core defines first and second axial end surfaces. A balance ring is rotationally fixed to the rotor assembly and is configured to rotationally balance the rotor assembly. The balance ring comprises a magnetically permeable material having a relative permeability of at least about 50 and is disposed proximate the first axial end surface and defines an air gap disposed axially between the balance ring and the first axial end surface.

In some variants of such an electrical machine, the electric machine includes a plurality of spacers extending between the first axial end surface and the balance ring. In other embodiments, the rotor core and balance ring may comprise a plurality of stacked laminations having a relative permeability of at least about 2,000.

Another embodiment comprises an electric machine that includes a stator and a rotor assembly. The rotor assembly defines a rotational axis and has a rotor core wherein the rotor core defines first and second axial end surfaces and a plurality of axially extending slots defining openings in each of the first and second axial end surfaces. The rotor assembly also includes a plurality of permanent magnets wherein each of the permanent magnets is disposed in one of the slots. First and second balance rings are rotationally fixed to the rotor assembly and are configured to rotationally balance the rotor assembly. Each of the first and second balance rings comprises a magnetically permeable material having a relative permeability of at least about 50 with the first balance ring being disposed proximate the first axial end surface and defining a first air gap disposed axially between the first balance ring and the first axial end surface and the second balance ring being disposed proximate the second axial end surface and defining a second air gap disposed axially between the second balance ring and the second axial end surface.

In some variants, the axially extending slots define, relative to the rotational axis, an innermost radial dimension and an outermost radial dimension and the first and second balance rings each have a radially inner perimeter no greater than the innermost radial dimension of the slots and a radially outer perimeter no less than the outermost radial dimension of the slots and wherein the electric machine also includes a resolver operably coupled with the rotor assembly with the first balance ring being axially disposed between the resolver and the first axial end surface.

Yet another embodiment comprise a method of manufacturing an electric machine. The method includes providing stator; stacking a plurality of laminations to form a rotor core and assembling the rotor core in a rotor assembly; and coupling the rotor assembly with the stator wherein the rotor assembly defines a rotational axis. The method also includes stacking a plurality of magnetically permeable laminations having a relative permeability of at least about 50 to form a first balance ring; rotationally fixing the first balance ring to the rotor assembly wherein the first balance ring defines an air gap disposed axially between the first balance ring and the first axial end surface; and selectively altering the mass of the first balance ring to rotationally balance the rotor assembly.

In some variants, the method also includes the step of forming a plurality of spacers in one of the laminations forming the rotor core and the first balance ring and engaging the plurality of spacers with an oppositely disposed lamination facing the air gap to defining the air gap between the first balance ring and first axial end surface. In still other embodiments, the method also includes forming a plurality of axially extending slots in the rotor core wherein the plurality of slots define a plurality of slot openings on each of the first and second axial end surfaces and a permanent magnet is installed in each of the slots and wherein each of the spacers is spaced apart from the slot openings.

### BRIEF DESCRIPTION OF THE DRAWINGS

The above mentioned and other features of this invention, and the manner of attaining them, will become more apparent and the invention itself will be better understood by reference to the following description of an embodiment of the invention taken in conjunction with the accompanying drawings, wherein:

FIG. 1 is a perspective view of a rotor assembly.

FIG. 2 is a cross sectional view of an electric machine.

FIG. 3 is an enlarged partial cross section of the rotor assembly of FIG. 1.

FIG. 4 is a partial cut-away perspective view of the rotor assembly of FIG. 1.

FIG. 5 is a perspective view of another rotor assembly.

FIG. 6 is a side view of the rotor assembly of FIG. 5.

FIG. 7 is a partial cross section of the rotor assembly of FIG. 5.

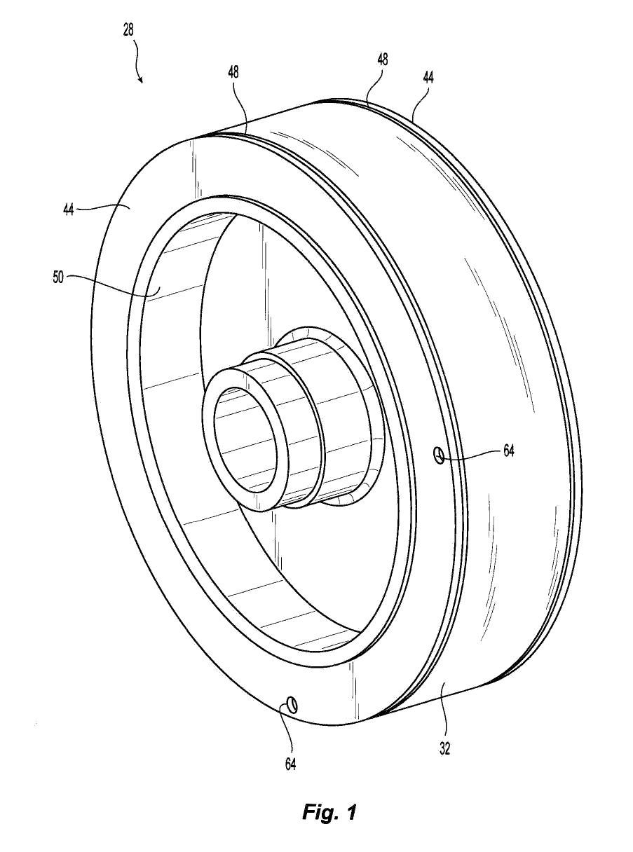

Corresponding reference characters indicate corresponding parts throughout the several views. Although the exemplification set out herein illustrates an embodiment of the invention, in one form, the embodiment disclosed below is not intended to be exhaustive or to be construed as limiting the scope of the invention to the precise form disclosed.

### DETAILED DESCRIPTION

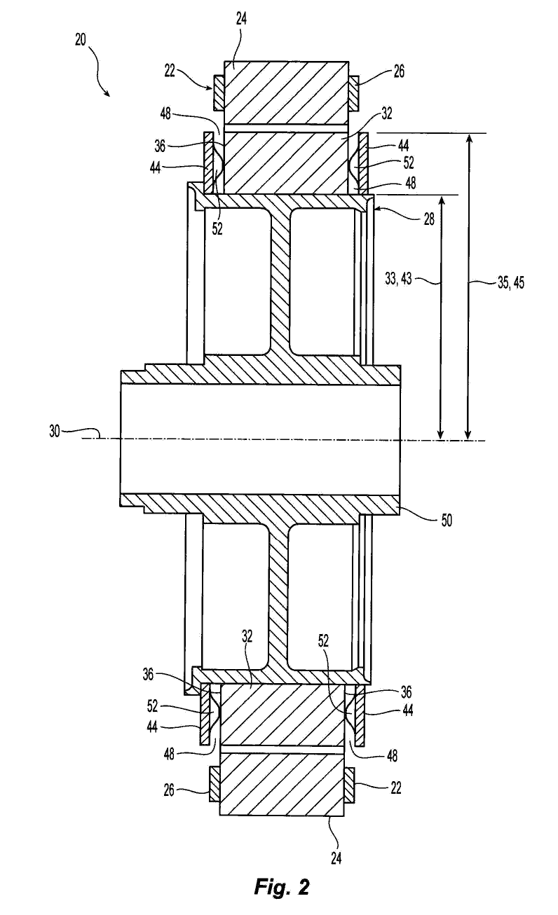

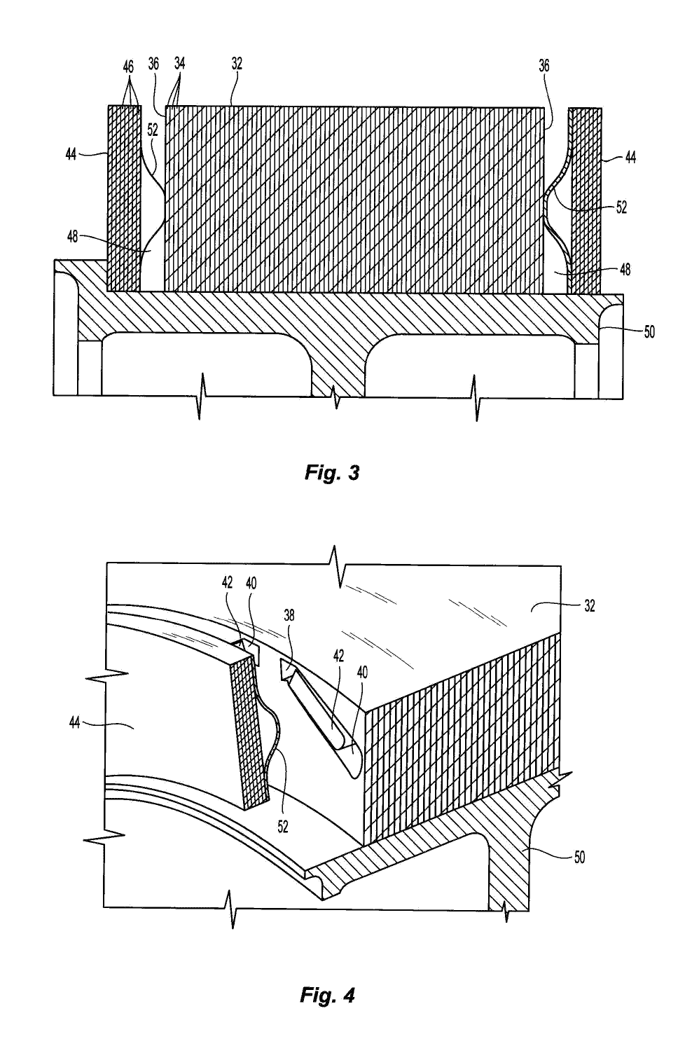

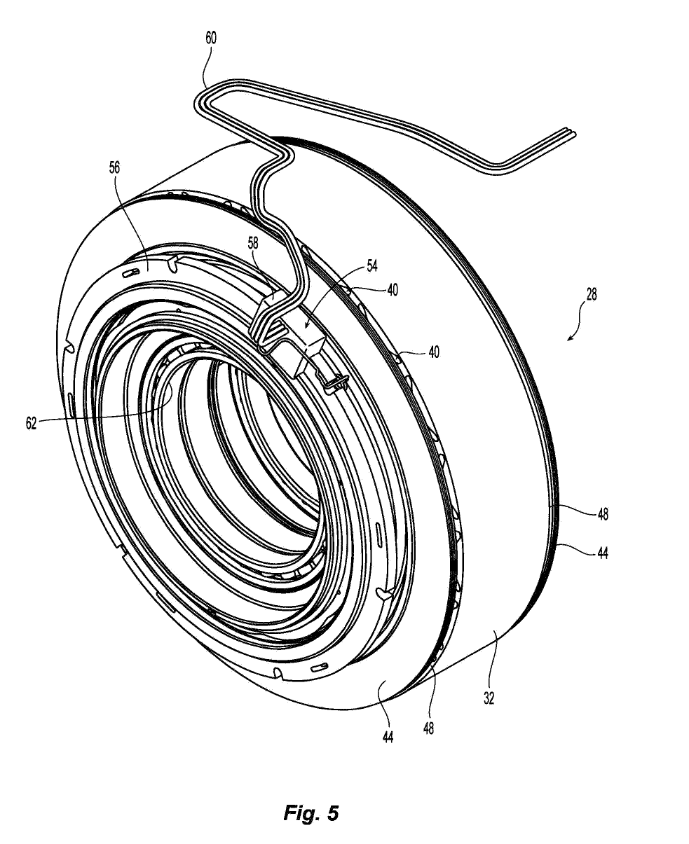

An electric machine 20 is schematically depicted in FIG. 2 and includes a stator 22 having a stator core 24 and windings 26. Stator 22 has a conventional structure with stator core 24 being formed out of a plurality of stacked metal laminations and has axially extending slots for receiving windings 26.

A rotor assembly 28 is rotatably coupled with stator 22 and rotates about axis 30. Rotor assembly 28 includes a rotor core 32 that is formed by a plurality stacked metal laminations 34. Laminations 34 on the opposite ends of rotor core 32 define opposite axial end surfaces 36 of rotor core 32. Rotor core 32 defines a plurality of axially extending slots 38 which define openings 40 in axial end surfaces 36. Magnets 42 are disposed in slots 38 and are made of a material that is capable of acting as a permanent magnet when installed in rotor core 32.

Magnets 42 may either be magnetized prior to installation in rotor core 32 or may be non-magnetized when installed and have magnetic properties imparted to them after installation in rotor core 32. Magnets 42 may be advantageously formed out of neodymium iron boron. Dysprosium may be included when forming magnets 42 to provide greater temperature stability and allow the magnetic material to better resist the loss of magnetism. A variety of other materials may also be used to form magnets 42 including rare earth materials such as lithium, terbium and samarium. The use of these and other magnetic materials to form permanent magnets for use in electric machines is well-known to those having ordinary skill in the art. Magnets 42 may also include an outer layer of material such as a layer of nickel formed on the magnetic material by electroplating or a layer of aluminum formed by vapor diffusion that forms an outer coating on the magnet. Such outer coatings can be used to enhance resistance to corrosion.

In the illustrated embodiments, slots 38 are fully encircled by the material forming rotor core 32. In alternative embodiments, however, slots 38 could extend outwardly to the outer radial perimeter of rotor core 32 and thereby form open-ended slots with an opening that extends axially along the outer radial surface of rotor core 32. In still other embodiments, rotor assembly 28 could include magnets 42 that are attached at the outer radial surface of rotor core 32 instead of in axially extending slots.

Balance rings 44 are used to rotationally balance rotor assembly 28. Balance rings 44 are rotationally fixed to rotor assembly 28, in other words, balance rings 44 rotate together with rotor assembly 28 and have mass selectively removed therefrom to balance assembly 28 as discussed in greater detail below. In the illustrated embodiments, balance rings 44 are formed out of an electrically conductive and magnetically permeable material. Most ferrous metals are electrically conductive and magnetically permeable and balance rings 44 are advantageously formed out of a ferrous metal such as electrical steel laminations 46. Rotor and stator cores of electrical machines are commonly formed out of stacked electrical steel laminations. Electrical steel laminations are formed out of an iron alloy and typically include silicon in amounts which may range up to approximately 6.5% but are typically no greater than approximately 2 to 3.2%. Magnesium and aluminum, in amounts up to approximately 0.5%, may also be used in electrical steel. Electrical steel is widely available and well-known to those having ordinary skill in the art.

Although the illustrated balance rings 44 are formed by stacking laminations, other methods of forming balance rings 44 may also be employed. For example, balance rings 44 can be formed out of a “slinky” lamination, i.e., a long strip of magnetically permeable material which is helically wound into a toroidal shape to reduce waste. Balance rings may also be formed out of a billet of magnetically permeable material which is machined and/or stamped to form the balance ring. Alternatively, strips of magnetically permeable material may be formed into a ring and welded. Still other manufacturing methods may also be employed to provide a ring of magnetically permeable material suitable for use as balance ring 44.

Balance rings 44 are each disposed proximate, and axially spaced from, one of the axial end surfaces 36 of rotor core 32 to thereby define an air gap 48 that is disposed axially between each of the balance rings 44 and a respective one of the axial end surfaces 36. Although balance rings 44 do not fully enclose electric machine 20, the use of magnetically permeable material to form rings 44 and air gaps 48 allows rings 44 to act in a manner similar to a Faraday cage and provide some directional shielding from the magnetic flux which is generated by the operation of electric machine 20. Thus, balance rings 44 not only provide a means for rotationally balancing rotor assembly 28 but also provide some shielding for electromagnetic interference (“EMI”).

In this regard, it is noted that magnetic permeability refers to the ability of a material to support the formation of a magnetic field within itself. A magnetically permeable material will exhibit magnetization in response to an applied magnetic field. Magnetically permeability is measured in henrys per meter or newtons per ampere squared. The permeability constant, μ₀, is defined as the permeability of free space, i.e., a vacuum. The relative permeability of a material is the ratio of the magnetic permeability of that material to the permeability constant. A high relative permeability indicates that the material has a greater ability to support the formation of a magnetic field within itself. Air has a relative permeability of approximately 1 while highly magnetizable silicon steel, e.g., 4% Si Steel, will often have a relative permeability of at least about 2,000. Electrical steel typically has a relative permeability in a range from about 3,000 to about 8,000.

Aluminum and stainless steel, two materials which are often used to form balance rings, are generally considered to be non-magnetic and have a relative permeability falling in a range from about 1 to about 2. Ferrous metal materials will generally have the ability to support a magnetic field within themselves and have a higher relative permeability. For example, carbon steel typically has a relative permeability of about 50 to 100. Carbon steel having a relative permeability of at least about 50 could be employed to provide a magnetically permeable balance ring 44 with EMI shielding properties which, for some applications, may be advantageous. The use of a silicon or electrical steel having a magnetic permeability of at least about 2,000, however, would provide greater EMI shielding properties.

In the illustrated embodiment, balance rings 44 have an axial thickness of approximately 5 to 6 mm while air gap 48 has an axial thickness of approximately 4 mm. These dimensions will vary depending upon the size and operating characteristics of electric machine. The thickness of balance rings 44 will be primarily a function of the mass necessary to balance rotor assembly 28 while the thickness of air gap 48 will be primarily a function of the magnitude of the magnetic flux generated by the operation of electric machine 20.

It is noted that the illustrated embodiments employ a balance ring 44 at each of the opposite axial ends of rotor core 32. In alternative embodiments, however, a single balance ring 44 could be employed with electric machine 20, or, a single balance ring 44 with EMI shielding properties could be employed on one axial end of rotor core 32 and a second balance ring with differing properties could be employed on the opposite end of rotor core 32.

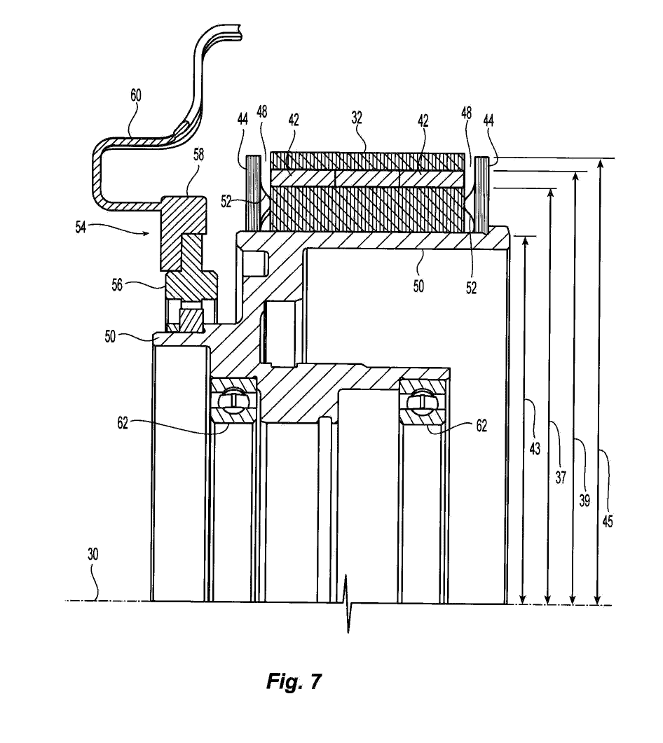

The illustrated rotor assemblies 28 include a rotor hub 50 on which both the rotor core 32 and balance rings 44 are mounted on and rotationally fixed. As can be seen in FIG. 7, bearing races 62 may be mounted within hub 50. Bearing races 62 engage a fixed shaft (not shown) which thereby allows rotor assembly 28, including hub 50, rotor core 32 and balance rings 44, to rotate about the fixed shaft.

Balance rings 44 and rotor core 32 can be mounted on hub 50 by differentially applying thermal energy to balance rings 44 and rotor core 32 versus hub 50. For example, balance rings 44 and rotor core 32 can be heated to cause thermal expansion and thereby allow hub 50 to be inserted into the central opening of rings 44 and core 32. Hub 50 can also be cooled to further facilitate the mounting of rings 44 and core 32 thereon. Once rings 44 and core 32 are positioned on hub 50 and all of these parts are allowed to all return to the ambient temperature, rings 44 and core 32 will be tightly engaged with and fixed to hub 50.

A plurality of spacers 52 which extend between an axial end surface 36 and balance ring 44 may be used to position balance rings 44 at a predetermined distance from axial end surfaces 36. Advantageously, spacers 52 are formed out of one of the laminations 34, 46 forming rotor core 32 or balance rings 44. More specifically, spacers 52 can be formed in a lamination 34, 46 of rotor core 32 or balance ring 44 which is positioned facing air gap 48 and engages the lamination 34, 46 located on the opposite side of the air gap 48 that also faces the air gap.

In the illustrated embodiments, spacers 52 are formed in a lamination 46 which form part of balance rings 44 and are formed by stamping dimples in lamination 46. When forming the illustrated spacers 52, lamination 46 is deformed without cutting or tearing the laminations. Alternative methods of forming stand-offs or spacers may also be used when creating air gaps 48. For example, the stamping of lamination 46 could cut through the thickness of lamination leaving an attached tab that is bent out of the plane of a lamination 34, 46 to form a spacer. In still other alternative embodiments, one or more separate parts distinct from the laminations 34, 46 facing air gap 48 could be positioned between balance ring 44 and rotor core 32 to act as spacers. Such separate spacers could be formed out of nonconductive and/or non-magnetically permeable material such as a resinous polymeric material.

In still other embodiments, air gap 48 can be formed by the use of assembly fixtures during the manufacture of rotor assembly 28 wherein the assembly fixtures do not form a part of the final rotor assembly 28. When using spacers 52, the spacers 52 do occupy a portion of the space between balance ring 44 and rotor core 32 but it is only a small fraction of that space and spacers 52 still allow for the creation of an air gap 48 between balance ring 44 and rotor core 32. It is further noted that when spacers 52 are formed out of a conductive and magnetically permeable material, the spacers 52 are positioned so that they will not engage the axial ends of magnets 42 and, thus, will not provide a short circuit pathway for magnetic flux between magnets 42 which would degrade the operation of electric machine 20. Stated in other words, such spacers 52 are spaced apart from slot openings 40 in which magnets 42 are located. If spacers 52 are formed out of a non-magnetically permeable material such as a polymeric resin, the spacers 52 could engage rotor core 32 at the location of magnets 42. When using magnetically permeable spacers 52, it is also generally desirable to position the spacers at a radially inward location instead of near the outer diameter of rotor core 32 where the magnetic flux density is greatest. For example, the embodiment depicted in FIG. 7 advantageously positions spacers 52 radially inwardly of the innermost radial position 37 of slots 38 and, thus, also positions spacers 52 radially inwardly of magnets 42.

Advantageously, rotor core 32 and balance rings 44 are formed out of a plurality of stacked electrical steel laminations 34, 46 wherein axially extending slots 38 define, relative to rotational axis 30, an innermost radial dimension 37 and an outermost radial dimension 39. Balance rings 44 have a radially inner diameter 43 no greater than the innermost radial dimension 37 of slots 38 and a radially outer diameter 45 no less than the outermost radial dimension 39 of slots 38. Innermost 37 and outermost 39 limits of slots 38 are schematically depicted in FIG. 7. This configuration ensures that, in parallel planes oriented perpendicular to axis 30, balance rings 44 have a surface area that extends over the same area in which magnets 42 are located. This, in turn, enhances the EMI shielding properties of balance rings 44.

In the illustrated embodiment, laminations 34 forming rotor core 32 have an inner diameter 33 and an outer diameter 35 which are equivalent to the inner diameter 43 and outer diameter 45 of laminations 46 forming balance rings 44. This configuration allows for the efficient manufacture of electric machine 20. For example, when laminations 34, 46 have the same inner and outer diameter, they can be easily stamped in the same progressive die assembly. The use of a common inner diameter allows both balance rings 44 and rotor core 32 to be mounted on the same diameter shaft thereby facilitating the mounting of rings 44 and core 32 on rotor hub 50.

The use of the same material to form laminations 34 and 46 when using a common inner diameter also simplifies the design of electric machine due to their common coefficient of thermal expansion. If both laminations 34 and 46 are mounted on the same rotor hub using a press-fit engagement, it is necessary to account for the thermal expansion of the laminations vis-à-vis rotor hub 50 during operation of electric machine 20 to ensure that the laminations do not become loose on rotor hub 50 throughout the operating temperature range of electric machine 20. If two different materials are used to form laminations 34 and 46 this complicates this design consideration while using a common material to form both laminations 34 and 46 simplifies it.

For example, a balance ring formed out of aluminum or stainless steel would have a different coefficient of thermal expansion than rotor core laminations 34 formed out of electrical steel and might require a different method of securement to rotor hub 50. It is also noted that the use of aluminum, stainless steel or other material having a low magnetic permeability to form a balance ring would not provide the EMI shielding provided by a magnetically permeable balance ring, e.g., a balance ring formed out of a ferrous metal such as electrical steel.

The use of a common outer diameter is also beneficial by facilitating the insertion of rotor assembly 28 into stator 22 while allowing rings 44 to extend over the entirety of end surfaces 36 and thereby enhance EMI shielding. While the depicted laminations 34, 46 have the same inner and outer diameters and such a configuration provides several benefits, alternative embodiments may also employ balance rings 44 formed out of laminations 46 having an inner diameter and/or outer diameter that differ from that of the laminations 34 forming rotor core 32.

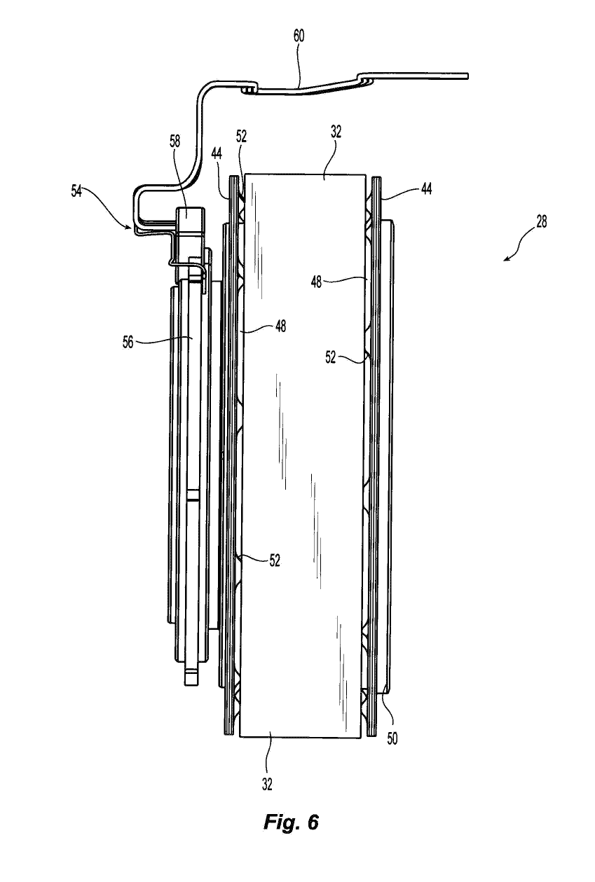

Turning now to FIGS. 5-7, a rotary encoder or resolver 54 operably coupled with rotor assembly 28 is schematically depicted. The use of rotary encoders and resolvers 54 are well known to those having ordinary skill in the art and are often used to determine the rotational speed and/or angular position of a rotating shaft. For example, in a generator/traction motor for a hybrid vehicle, resolvers are often used to determine the angular position of the rotor assembly whereby a controller can utilize this information when controlling the operation of an inverter operably coupled with the generator/traction motor.

Illustrated resolver 54 includes a rotating element 56, e.g., a lamination stack 8 to 10 mm thick with a wave cut forming a 30 to 40 mm outer diameter, which rotates together with rotor assembly 28 and a reading element 58 which does not rotate with rotor assembly 28. Wiring 60 conveys signals from resolver 54 to a control unit (not illustrated).

In some applications, rotary encoders and resolvers may be adversely impacted by EMI generated by an electric machine coupled therewith and the EMI shielding provided by balance rings 44 can be beneficial to the operation of such rotary encoders and resolvers. In the embodiment depicted in FIG. 7, one of the balance rings 44 is axially disposed between resolver 54 and rotor core 32 to provide at least some EMI shielding to resolver 54.

The manufacture of electric machine will now be discussed. Stator 22 is manufactured using conventional techniques well-known to those having ordinary skill in the art. Stator core 24 may be advantageously formed by stacking laminations of electrical steel which are stamped out of sheet metal in a progressive die assembly. Wire wound into coils is then inserted in slots in stator core 24 to form windings 26.

To form rotor core 32, a plurality of electrical steel laminations 34 are stamped and stacked in a progressive die assembly. Balance rings 44 are advantageously formed by stamping and stacking conductive and magnetically permeable laminations 46, e.g., electrical steel laminations, in the same progressive die assembly as laminations 34.

Progressive die assemblies generally include multiple stamping stations which can be selectively operated whereby the same progressive die assembly can be used to rapidly stamp laminations from the same stock material which have different configurations, within limits, due to the selective operations of particular stamping stations as the portion of the stock material used to form a particular lamination progresses through the die assembly.

The progressive die is used to stamp slot openings in each of the laminations 34 used to form rotor core 32 and laminations 34 are aligned so that the stamped openings in laminations 34 form axially extending slots 38 when laminations 34 are stacked. The two laminations 34 at opposite ends of rotor core 32 define axial end surfaces 36 having openings 40 to axially extending slots 38. The laminations forming rotor core 32 can be secured together by welding, adhesives, inter-engaged tabs and slots in adjacent laminations, or by other suitable methods. For example, one adhesive method of securing laminations involves the use of a two part epoxy wherein one part is applied to the bottom surface of each of the laminations and the other is applied to the top surface of each of the laminations. Once stacked, the laminations are heated to adhere the two parts together and form a bonded core.

Magnets 42 are inserted into slots 38 through one of the openings 40 and, as discussed above, may be magnetized prior to installation in rotor core 32 or may be non-magnetized when installed and be magnetized after installation. Magnets 42 can be retained in slots 38 by means of an adhesive, by a press-fit engagement with rotor core 32, or other suitable means. For example, rotor core 32 can be heated to thermally expand the size of rotor core 32, and slots 38, providing sufficient clearance for magnets 42 to be inserted into slots 38. Magnets 42 may also be chilled to reduce their dimensions. The rotor core 32 and magnets 42 are then allowed to return to ambient temperature with the rotor core 32 and magnets 42 being dimensioned such that magnets 42 are firmly engaged by rotor core 32 and secured therein when core 32 and magnets 42 are at the same temperature.

As mentioned above, balance ring laminations 46 can advantageously be stamped out of the same stock material and in the same progressive die assembly as rotor core laminations 34. When stamping laminations 46, spacers 52 can be formed by forming dimples, without breaking the surface, in those laminations 46 which will face rotor core 32. Alternatively, spacers 52 could be formed by cutting and bending tabs out of the plane of a lamination 46. Or, as discussed above, such dimples or tabs could be formed in the laminations 34 defining the axial end surfaces 36 of rotor core 32, or, be separate from laminations 34, 46.

As mentioned above, laminations 34, 46 advantageously have substantially equivalent radially inner perimeters 33, 43 and substantially equivalent radially outer perimeters 35, 45. The use of common inner and outer diameters facilitates the stamping of laminations 34, 46 in the same progressive die assembly by allowing the inner and outer diameters of both laminations 34 and laminations 46 to be stamped using the same tooling at the same station. Similar to rotor core 32, the laminations 46 forming balance rings 44 can be secured together by welding, adhesives, inter-engaged tabs and slots in adjacent laminations, or by other suitable methods.

When stamping laminations 34, 46 from the same stock material, the order in which laminations 34, 46 are stamped can vary. For example, it would be possible to stamp, in sequential order, the laminations necessary to form the upper balance ring 44, rotor core 32 and then the lower balance ring 44 with this series of laminations be continuously repeated to thereby repeatedly stamp all the laminations needed for the rotor assembly of a single electric machine. Alternatively, the laminations 34 required for a plurality of rotor cores 32 could be stamped, followed by the stamping of the laminations 46 needed to form the balance rings 44 for that plurality of rotor cores 32. Still other variations may prove beneficial depending upon the available machinery, labor and facility layout.

After forming balance rings 44 and rotor core 32, the rotor core can be assembled. Balance rings 44 and rotor core 32 can be installed on rotor hub 50 by heating balance rings 44 and rotor core 32 to enlarged their inner diameter dimension and inserting rotor hub 50. Balance rings 44 and rotor core 32 can be dimensioned so that once balance rings 44, rotor core 32 and rotor hub 50 equalize at ambient temperature, balance rings 44 and rotor core 32 firmly engaged rotor hub 50 and are thereby mounted on and rotationally fixed thereto. It may also be desirable to chill rotor hub 50 to provide further clearance when inserting rotor hub 50 into balance rings 44 and rotor core 32. Advantageously, magnets 42 are installed in slots 38 after heating rotor core 32 and immediately prior to installing the heated balance rings 44 and rotor core 32 on rotor hub 50 to thereby form rotor assembly 28.

When installing balance rings 44 and rotor core 32 on hub 50, spacers 52 on balance rings 44 are engaged with axial end surfaces 36 on rotor core 32 to form air gaps 48. Balance rings 44 are oriented relative to rotor core 32 such that each of the spacers 52 are spaced apart from slot openings 40 and do not engage magnets 42 when spacers 52 are brought into contact with axial end surfaces 36.

As mentioned above, balance rings 44 and rotor core 32 can be rotationally fixed relative to rotor assembly 28 by mounting the balance rings 44 and rotor core 32 on and rotationally fixing them to rotor hub 50. Alternative methods of rotationally fixing balance rings 44 and rotor core 32 could also be employed. For example, balance rings 44 could be welded to rotor core 32 or both balance rings 44 and rotor core 32 could be welded to a common part.

In many electric machines, particularly those having high rotational speeds, it is important that rotor assembly 28 be rotationally balanced about its rotational axis 30. Unbalanced rotor assemblies can vibrate excessively ultimately resulting in premature damage or failure of the electric machine. To prevent excessive vibration, the mass of rotor assembly 28 can be selectively altered to rotationally balance rotor assembly 28 in a manner analogous to that used to rotationally balance vehicle tires. For example, after assembling rotor assembly 28, commercially available equipment can be used to rotate and analyze rotor assembly 28. After such analysis, the mass of balance rings 44 can be selectively altered to rotationally balance the rotor assembly 28 as a whole. For example, holes 64 can be drilled in one or both of the balance rings 44 at locations determined by the analysis to rotationally balance rotor assembly 28. It would also be possible to initially provide balance rings 44 with circumferentially spaced openings or voids and fill selected voids and thereby add mass to balance rings 44 to balance rotor assembly 28. For example, some of the laminations 46 could be provided with openings to form circumferentially spaced voids. Advantageously, such voids would not fully penetrate the axial thickness of balance ring 44 whereby any negative impact of such voids on the EMI shielding properties of the balance ring could be minimized or prevented.

Rotor assembly 28 is coupled with stator 22 such that rotor assembly 28 is rotatable about axis 30. Depending upon the application for which electric machine 20 is being manufactured, it may be desirable to operably couple a resolver 54 with rotor assembly 28. Advantageously, a balance ring 44 is axially disposed between resolver 54 and rotor core 32 to whereby the balance ring 44 can provide at least some EMI shielding to resolver 54.

While specific embodiments and methods of manufacture have been described, various modifications to such embodiments and methods are still within the scope of the present invention. For example, rather than using a plurality of laminations to form balance rings 44, it would also be possible to form a monolithic balance ring out of an electrically conductive and magnetically permeable material and space it from rotor core 32 to form an air gap 48. In still other embodiments, a single balance ring 44 could be used with electric machine 20 instead of two balance rings.

In still other embodiments, two different types of balance rings 44 could be used with in the same electric machine. For example, a balance ring 44 formed out of electrically conductive and magnetically permeable material could be positioned at one end of the rotor core 32 positioned axially between the rotor core 32 and resolver 54 while on the opposite end of the rotor core 32, a balance ring formed out of a less electrically conductive and less magnetically permeable material could be used. It will, however, generally be advantageous to use similar balance rings 44 on each axial end of the rotor assembly.

While this invention has been described as having an exemplary design, the present invention may be further modified within the spirit and scope of this disclosure. This application is therefore intended to cover any variations, uses, or adaptations of the invention using its general principles.

What is claimed is:

1. An electrical machine comprising:
a stator;
a rotor assembly defining a rotational axis and having a rotor core wherein the rotor core defines first and second axial end surfaces; and
a balance ring rotationally fixed to the rotor assembly, the balance ring being configured to rotationally balance the rotor assembly wherein the balance ring comprises a magnetically permeable material having a relative permeability of at least about 50 and is disposed proximate the first axial end surface and defines an air gap disposed axially between the balance ring and the first axial end surface.

2. The electric machine of claim 1 further comprising a plurality of spacers extending between the first axial end surface and the balance ring.

3. The electric machine of claim 2 further comprising a plurality of permanent magnets wherein the rotor core defines a plurality of axially extending slots each of the slots defining a slot opening in the first axial end surface and wherein each of the plurality of permanent magnets is disposed in one of the slots and wherein the spacers are spaced apart from the slot openings.

4. The electric machine of claim 1 wherein both the rotor core and the balance ring comprise a plurality of stacked laminations having a relative permeability of at least about 2,000.

5. The electric machine of claim 4 further comprising a plurality of spacers extending between the first axial end surface and the balance ring wherein the spacers are formed from one of the laminations forming the rotor core and balance ring.

6. The electric machine of claim 4 wherein the rotor assembly further comprises a rotor hub wherein both the rotor core and the balance ring are mounted on and rotationally fixed to the rotor hub.

7. The electric machine of claim 1 further comprising a resolver operably coupled with the rotor assembly and wherein the balance ring is axially disposed between the resolver and the rotor core.

8. The electric machine of claim 1 wherein the magnetically permeable material is a ferrous metal having a relative permeability of at least about 100.

9. An electric machine comprising:
a stator;
a rotor assembly defining a rotational axis and having a rotor core wherein the rotor core defines first and second axial end surfaces and a plurality of axially extending slots defining openings in each of the first and second axial end surfaces;
a plurality of permanent magnets wherein each of the permanent magnets is disposed in one of the slots; and
first and second balance rings rotationally fixed to the rotor assembly and configured to rotationally balance the rotor assembly wherein each of the first and second balance rings comprises a magnetically permeable material having a relative permeability of at least about 50 and wherein the first balance ring is disposed proximate the first axial end surface and defines a first air gap disposed axially between the first balance ring and the first axial end surface and the second balance ring is disposed proximate the second axial end surface and defines a second air gap disposed axially between the second balance ring and the second axial end surface.

10. The electric machine of claim 9 further comprising a first plurality of spacers extending between the first axial end surface and the first balance ring and a second plurality of spacers extending between the second axial end surface and the second balance ring.

11. The electric machine of claim 9 wherein each of the rotor core and the first and second balance rings comprise a plurality of stacked electrically conductive laminations having a relative permeability of at least about 3,000.

12. The electric machine of claim 11 further comprising a first plurality of spacers extending between the first axial end surface and the first balance ring and a second plurality of spacers extending between the second axial end surface and the second balance ring wherein the first plurality of spacers are formed from a first one of the laminations forming the first balance ring and the rotor and the second plurality of spacers are from a second one of the laminations forming the second balance ring and the rotor.

13. The electric machine of claim 9 wherein the rotor assembly further comprises a rotor hub wherein each of the first and second balance rings and the rotor core are mounted on and rotationally fixed to the rotor hub.

14. The electric machine of claim 9 wherein the axially extending slots define, relative to the rotational axis, an innermost radial dimension and an outermost radial dimension, the first and second balance rings each having a radially inner perimeter no greater than the innermost radial dimension of the slots and a radially outer perimeter no less than the outermost radial dimension of the slots and wherein the electric machine further comprises a resolver operably coupled with the rotor assembly wherein the first balance ring is axially disposed between the resolver and the first axial end surface.

15. A method of manufacturing an electric machine comprising:
providing stator;
stacking a plurality of laminations to form a rotor core and assembling the rotor core in a rotor assembly;
coupling the rotor assembly with the stator wherein the rotor assembly defines a rotational axis;
stacking a plurality of magnetically permeable laminations having a relative permeability of at least about 50 to form a first balance ring;
rotationally fixing the first balance ring to the rotor assembly wherein the first balance ring defines an air gap disposed axially between the first balance ring and the first axial end surface; and
selectively altering the mass of the first balance ring to rotationally balance the rotor assembly.

16. The method of claim 15 further comprising the step of forming a plurality of spacers in one of the laminations forming the rotor core and the first balance ring and wherein defining an air gap between the first balance ring and first axial end surface comprises engaging the plurality of spacers with an oppositely disposed lamination facing the air gap.

17. The method of claim 16 further comprising:
forming a plurality of axially extending slots in the rotor core wherein the plurality of slots define a plurality of slot openings on each of the first and second axial end surfaces;
installing a permanent magnet in each of the slots; and
wherein each of the spacers is spaced apart from the slot openings and positioned radially inwardly of the permanent magnets.

18. The method of claim 17 further comprising:
stacking a plurality of magnetically permeable laminations with a relative permeability of at least about 50 to form a second balance ring;
rotationally fixing the second balance ring relative to the rotor assembly wherein the second balance ring defines a second air gap disposed axially between the second balance ring and the second axial end surface wherein each of the first and second balance rings and the rotor core are mounted on and rotationally fixed to a rotor hub;
selectively altering the mass of the second balance ring to rotationally balance the rotor assembly; and
forming a second plurality of spacers in one of the laminations forming the rotor core and the second balance ring and wherein defining a second air gap between the second balance ring and second axial end surface comprises engaging the second plurality of spacers with an oppositely disposed lamination facing the second air gap with each of the second plurality of spacers being spaced apart from the slot openings.

19. The method of claim 18 wherein the laminations used to form the rotor core and the first and second balance rings have a relative permeability of at least about 2,000; and
wherein the axially extending slots define, relative to the rotational axis, an innermost radial dimension and an outermost radial dimension, the first and second balance rings each having a radially inner perimeter no greater than the innermost radial dimension of the slots and a radially outer perimeter no less than the outermost radial dimension of the slots.

20. The method of claim 19 wherein the laminations forming the rotor core and the first and second balance all define substantially equivalent radially inner perimeters and substantially equivalent radially outer perimeters and the method further comprises the step of operably coupling a resolver with the rotor assembly wherein the first balance ring is axially disposed between the resolver and the first axial end surface.
